(19) United States
(12) Patent Application Publication
(10) Pub. No.: US 2008/0155964 A1
(43) Pub. Date: Jul. 3, 2008

(54) Engine control system based on soot loading

(75) Inventor: Jonathan Patrick Kilkenny, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/646,544

(22) Filed: Dec. 28, 2006

(51) Int. Cl. F02D 41/04; F01N 3/00

(52) U.S. Cl. 60/286; 701/103; 123/672

(57) ABSTRACT

A control system for an internal combustion engine having a particulate filter is disclosed. The control system may have a sensor configured to detect a performance parameter of the particulate filter and generate a corresponding signal. The control system may also have a controller in communication with the sensor and the internal combustion engine. The control system may be configured to receive the signal and determine a soot loading status of the particulate filter based on the signal. The control system may be further configured to modify operation of the internal combustion engine based on the soot loading status during normal operation of the particulate filter.

### TECHNICAL FIELD

The present disclosure is directed to an engine control system and, more particularly, to a system for controlling engine operation based on soot loading.

### BACKGROUND

Internal combustion engines, including diesel engines, gasoline engines, gaseous fuel-powered engines, and other engines known in the art exhaust a complex mixture of air pollutants. These air pollutants may be composed of gaseous compounds such as nitrogen oxides and carbon monoxide, and solid particulate matter also known as soot.

Due to increased awareness of the environment, exhaust emission standards have become more stringent, and the amount of gaseous compounds and particulate matter emitted from an engine may be regulated depending on the type of engine, size of engine, and/or class of engine. One method that has been implemented by engine manufacturers to comply with the regulation of emissions has been to remove the gaseous compounds and particulate matter from the exhaust flow of an engine using an exhaust treatment device. An exhaust treatment device typically includes a filter medium designed to trap particulate matter, and a catalyst utilized to absorb or convert the nitrogen oxides and/or carbon monoxide to innocuous gases.

However, use of the exhaust treatment device for extended periods of time can cause particulate matter to build up in the filter medium, thereby reducing the functionality of the exhaust treatment device and, subsequently, engine performance. For example, as the soot begins to block pores or mesh openings of the filter medium, the pressure differential across the filter medium and/or the temperature of the exhaust flowing through the filter medium may increase. As the exhaust pressure and temperature upstream of the filter medium builds, it becomes increasingly more difficult to draw or force the appropriate amount of fresh air into the engine. And, as a result of the reducing supply of fresh air, the air-to-fuel ratio within the engine decreases, thereby causing a change in the exhaust emission constituents and a further increase in both intake and exhaust gas temperature. If unaccounted for, the increasing pressure and temperatures can result in component failure, increased fuel consumption, loss of power, and/or failure to meet emission regulations.

To alleviate extreme symptoms associated with a clogged particulate trap, particulate matter collected therein may be periodically removed from the filter medium through a process called regeneration. To initiate regeneration of the filter medium, the temperature of the particulate matter entrained within the medium is elevated above a combustion threshold, at which the particulate matter is burned away. An example of increasing exhaust temperatures to regenerate a particulate trap is described in U.S. Pat. No. 6,948,476 (the '476 patent) issued to Gioannini et al. on Sep. 27, 2005. Specifically, the '476 patent discloses a method of varying operation of an engine (i.e., fuel injection characteristics of the engine) based on a need to regenerate a particulate trap. For example, the '476 patent discloses a fuel system that delivers fuel to a combustion chamber in a plurality of precisely defined post injection events such that the temperature of the particulate trap is raised sufficiently high to regenerate or burn away the trapped particulates. In this manner, excessive backpressure and temperatures resulting from a completely clogged filter medium may be alleviated.

Although the method of the '476 patent may periodically alter engine operation to suitably regenerate a particulate-saturated filter medium, it may be ineffective at reducing the negative affects associated with a partially loaded medium between regeneration events. Specifically, even though the particulate filter medium may be only partially loaded with soot and not yet ready for regeneration, the restriction through the filter medium may still be sufficient to negatively affect engine performance. In these situations, the engine, even when equipped with the regeneration strategy of the '476 patent, may still suffer from increased fuel consumption, elevated exhaust emissions, and decreased component life linked to elevated temperatures and pressures at the particulate filter.

The control system of the present disclosure solves one or more of the problems set forth above.

### SUMMARY OF THE INVENTION

One aspect of the present disclosure is directed to a control system for an internal combustion engine having a particulate filter. The control system may include a sensor configured to detect a performance parameter of the particulate filter and generate a corresponding signal. The control system may also include a controller in communication with the sensor and the internal combustion engine. The control system may be configured to receive the signal and determine a soot loading status of the particulate filter based on the signal. The control system may be further configured to modify operation of the internal combustion engine based on the soot loading status during normal operation of the particulate filter.

Another aspect of the present disclosure is directed to a method of controlling engine operation. The method may include determining a soot loading status of a particulate filter. The method may also include modifying operation of the engine based on the soot loading status during normal operation of the particulate filter.

### BRIEF DESCRIPTION OF THE DRAWINGS

FIG. 1 is a schematic and diagrammatic illustration of an exemplary disclosed power unit; and

FIG. 2 is a flowchart depicting an exemplary method of operating the power unit of FIG. 1.

### DETAILED DESCRIPTION

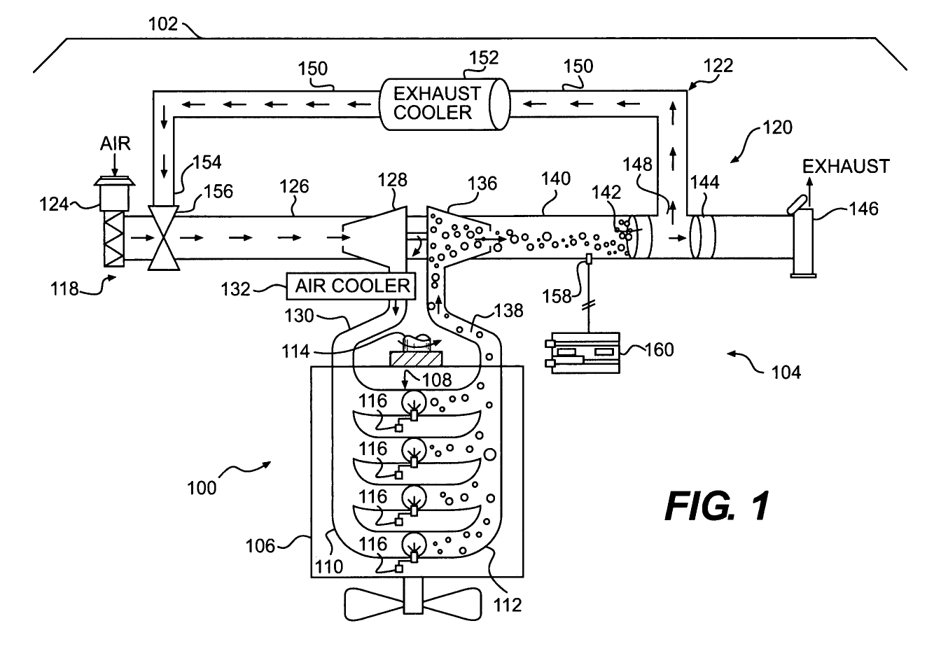

FIG. 1 illustrates a power unit 100 having an exhaust treatment system 102 and a control system 104. For the purposes of this disclosure, power unit 100 is depicted and described as a four-stroke diesel engine. One skilled in the art will recognize, however, that power unit 100 may be any other type of internal combustion engine such as, for example, a gasoline engine or a gaseous fuel-powered engine. Further, power unit 100 may be a non-engine type of power and exhaust producing device such as, for example, a furnace. Generally, power unit 100 may combust a fuel/air mixture to generate power and exhaust, and direct that exhaust to exhaust treatment system 102. Exhaust treatment system 102 may receive, treat, and direct the exhaust into the atmosphere.

Power unit 100 may include an engine block 106 that at least partially defines a plurality of combustion chambers 108 in fluid communication with both an intake manifold 110 and an exhaust manifold 112, a cylinder head (not shown) at least partially defining combustion chambers 108, and a crankshaft 114 rotatably disposed within engine block 106. In the illustrated embodiment, power unit 100 includes four combustion chambers 108. However, it is contemplated that power unit 100 may include a greater or lesser number of combustion chambers 108 and that combustion chambers 108 may be disposed in an “in-line” configuration, a “V” configuration, or any other suitable configuration. Each combustion chamber 108 may house a piston (not shown) connected to crankshaft 114 of power unit 100 such that a sliding motion of each piston within its respective combustion chamber 108 results in a rotation of crankshaft 114. Similarly, a rotation of crankshaft 114 may result in a sliding motion of the pistons.

Power unit 100 may compress and combust a mixture of fuel and air to produce a power output and exhaust. Each combustion chamber 108 may receive fuel and air, house the combustion of the fuel and air, and direct exhaust resulting from the combustion process to exhaust manifold 112. The exhaust may contain carbon monoxide, oxides of nitrogen, carbon dioxide, aldehydes, soot, oxygen, nitrogen, water vapor, and/or hydrocarbons such as hydrogen and methane. One skilled in the art will recognize that power unit 100 may include a plurality of other components such as a fuel tank, various control valves, a pre-combustion chamber, or other components consistent with the process of generating power and exhaust.

Intake manifold 110 may have one or more inlet ports, and direct air or a mixture of air and other gases through the inlet ports to combustion chambers 108. Similarly, exhaust manifold 112 may have one or more outlet ports, and receive exhaust from combustion chambers 108 via the outlet ports. It is contemplated that power unit 100 may contain a plurality of intake and/or exhaust manifolds to direct air and exhaust to and from combustion chambers 108, respectively.

A fuel injector 116 may be disposed within the cylinder head to inject an amount of pressurized fuel into an associated combustion chamber 108 at predetermined timings, fuel pressures, and quantities. Each fuel injector 116 may embody any type of electronically controlled fuel injection device such as, for example, an electronically actuated—electronically controlled injector, a mechanically actuated—electronically controlled injector, a digitally controlled fuel valve associated with a high pressure common rail, or any other type of fuel injector known in the art. It is contemplated that some or all parameters of the operation of fuel injectors 116 may be electronically controlled. For example, the timings, pressures, quantities, and/or velocities of the injections may be electronically controlled.

The timing of fuel injections into combustion chambers 108 may be synchronized with the motion of the pistons reciprocatingly disposed therein. For example, fuel may be injected as the pistons near a top-dead-center position in a compression stroke to allow for compression-ignited combustion of the injected fuel. Alternatively, fuel may be injected as the pistons begin the compression stroke heading towards a top-dead-center position for homogenous charge compression ignition operation. Fuel may also be injected as the pistons are moving from a top-dead-center position towards a bottom-dead-center position during an expansion stroke for a late post injection to create a reducing atmosphere for aftertreatment regeneration. In most situations, one or more shots of fuel may be injected into combustion chambers 108 during each 720 degree revolution of crankshaft 114. This combination of fuel shots during a single complete cycle or two revolutions crankshaft 114 may be known as an injection event. The electronic command signal sent to fuel injectors 116 that results in a particular combination of fuel injection shots may be considered a current waveform.

Exhaust treatment system 102 may include an air induction circuit 118, an exhaust circuit 120, and an exhaust gas recirculation (EGR) circuit 122. Air induction circuit 118 may draw air or a mixture of air and other gases into power unit 100 for combustion. Exhaust circuit 120 may direct a portion of the exhaust from power unit 100 to the atmosphere, while EGR circuit 122 may recirculate the remaining portion of the exhaust from exhaust circuit 120 to air induction circuit 118.

Air induction circuit 118 may include components that cooperate to introduce charged air into combustion chambers 108. For example, air induction circuit 118 may include an air inlet port 124, an intake passageway 126, a throttle valve 156, a compressor 128, an intake conduit 130, and an air cooler 132. It is contemplated that additional and/or different components may be included within air induction circuit 118 such as, for example, a wastegate for affecting the pressure of air within intake passageway 126 and/or intake conduit 130, a bypass circuit to selectively bypass air from intake conduit 130 to exhaust circuit 120, and other means known in the art for affecting the introduction of charged air into combustion chambers 108.

Air inlet port 124 may fluidly communicate with intake passageway 126, and may be associated with an air cleaner to clean the air entering air induction circuit 118. Throttle valve 156 may be located within intake passageway 126 and include a valve element such as, for example, a butterfly valve element, a gate valve element, a ball valve element, a globe valve element, or any other valve element known in the art. The valve element of throttle valve 156 may be movable between a flow-passing position and a flow-restricting position, and may be electronically controlled. The position of the valve element between the flow-passing and flow-restricting positions may, at least in part, affect the amount and resulting pressure of air flowing into power unit 100. More specifically, throttle valve 156 may selectively allow, block, or partially block the flow of air from the atmosphere into intake passageway 126, thereby adjusting the amount and pressure of air allowed into intake manifold 110. Intake passageway 126 may also fluidly communicate compressor 128 with air inlet port 124.

Compressor 128 may be fluidly connected within intake conduit 130 between air inlet port 124 and intake manifold 110 to compress the air flowing into power unit 100. Compressor 128 may embody a variable geometry compressor that changes its effective size as operating conditions of power unit 100 change. For example, compressor 128 may include a plurality of electronically-controlled vanes (not shown) that are moveable to effectively increase or decrease the cross-sectional area of compressor 128. As power unit 100 operates, the vanes of compressor 128 may be moved to increase or decrease the cross-sectional area of fins within compressor 128, thereby drawing in and compressing more or less air and affecting pressures within exhaust manifold 112. It is contemplated that Compressor 128 may alternatively embody a fixed geometry compressor, or any other type of compressor known in the art. It is also contemplated that multiple compressors 128 may alternatively be included within air induction circuit 118 and disposed in a series or parallel relationship. It is further contemplated, however, that compressor 128 may be absent, if a naturally-aspirated engine is desired.

Air cooler 132 may facilitate the transfer of heat to or from the air compressed by compressor 128, prior to the compressed air entering intake manifold 110. For example, air cooler 132 may embody an air-to-air heat exchanger or a liquid-to-air heat exchanger. Air cooler 132 may include a tube and shell type heat exchanger, a plate type heat exchanger, or any other type of heat exchanger known in the art. In the embodiment exemplified by FIG. 1, air cooler 132 is disposed downstream of compressor 128 and upstream of intake manifold 110. However, air cooler 132 may alternatively be located upstream of compressor 128 and/or between two compressors 128, if desired.

Exhaust circuit 120 may include components that treat and fluidly direct the exhaust from combustion chambers 108. For example, exhaust circuit 120 may include a turbine 136, an exhaust conduit 138, an exhaust passageway 140, a particulate filter 142, a catalytic device 144, and an exhaust port 146. It is contemplated that exhaust circuit 120 may include additional and/or different components than those recited above.

Turbine 136 may receive and be driven to rotate by the exhaust exiting combustion chambers 108 via exhaust manifold 112 and exhaust conduit 138. Turbine 136 may be connected to drive compressor 128, with turbine 136 and compressor 128, together, embodying a turbocharger. In particular, as the hot exhaust gases exiting power unit 100 expand against the blades (not shown) of turbine 136, turbine 136 may rotate and drive compressor 128. It is contemplated that more than one turbine 136 may alternatively be included within exhaust circuit 120 and disposed in a parallel or series relationship, if desired. Although not shown, the one or more turbines 136 may further be arranged in a turbocompounding configuration wherein at least one turbine is coupled with power unit 100 such that power produced by the turbine is returned to power unit 100. For example, a turbine may be disposed in a series relationship with turbine 136 and mechanically, hydraulically, or electrically linked to crankshaft 114 of power unit 100. It is also contemplated that turbine 136 may be omitted and compressor 128 driven by power unit 100 mechanically, hydraulically, electrically, or in any other manner known in the art, if desired.

After exiting turbine 136, the exhaust may be fluidly directed through exhaust passageway 140 to particulate filter 142. As exhaust from power unit 100 flows through exhaust passageway 140, particulate filter 142 may remove particulate matter from the exhaust flow. Particulate filter 142 may include, among other things, a wire mesh filtration medium, or ceramic honeycomb wall-flow style filter. It is contemplated that particulate filter 142 may include electrically conductive or non-conductive coarse mesh elements. It is also contemplated that particulate filter 142 may include a catalyst for reducing an ignition temperature of the particulate matter trapped by particulate filter 142, a means for regenerating the particulate matter trapped by particulate filter 142, or both a catalyst and a means for regenerating. The catalyst may support the reduction of HC, CO, and/or particulate matter, and may include, for example, a base metal oxide, a molten salt, and/or a precious metal. The means for regenerating may include, among other things, a fuel-powered burner, an electrically-resistive heater, an engine control strategy, or any other means for regenerating known in the art. Operation of particulate filter 142 may alternate between normal operation and regeneration events. That is, the operation of particulate filter 142 between regeneration events when the filtration medium is less than substantially saturated with soot may be regarded as normal operation of particulate filter 142.

Catalytic device 144 may also be disposed within exhaust passageway 140, downstream of particulate filter 142. Catalytic device 144 may include one or more substrates coated with or otherwise containing a liquid or gaseous catalyst such as, for example, a precious metal-containing washcoat. The catalyst may be utilized to reduce the byproducts of combustion in the exhaust flow by means of, for example, selective catalytic reduction or NOx trapping. In one example, a reagent such as urea may be injected into the exhaust flow upstream of catalytic device 144. The urea may decompose to ammonia, which may react with the NOx in the exhaust gas across the catalyst to form H₂O and N₂. In another example, NOx in the exhaust gas may be trapped by a NOx trap, such as a barium salt NOx trap, and periodically be released and reduced across the catalyst to form CO₂ and N₂. Catalytic device 144 may also oxidize particulate matter that remains in the exhaust flow after passing through particulate filter 142, if desired. After passing through catalytic device 144, the treated exhaust may then be fluidly directed through exhaust port 146 into the atmosphere.

EGR circuit 122 may include a means for redirecting a portion of the exhaust flow of power unit 100 from exhaust circuit 120 into air induction circuit 118. For example, EGR circuit 122 may include an EGR inlet port 148, an EGR passageway 150, an exhaust cooler 152, and an EGR outlet port 154. The flow of exhaust from EGR circuit 122 to air induction circuit 118 may be at least partially regulated by throttle valve 156, wherein throttle valve 156 acts as a mixing valve. Alternatively, EGR circuit 122 may include a separate EGR valve (not shown) to regulate the flow of exhaust from EGR circuit 122 to air induction circuit 118. It is contemplated that EGR circuit 122 may include additional and/or different components such as a catalyst, an electrostatic precipitation device, a shield gas system, a particulate trap, and other means known in the art for redirecting exhaust from exhaust circuit 120 into air induction circuit 118.

EGR inlet port 148 may be connected to exhaust circuit 120 to receive at least a portion of the exhaust flow from power unit 100. Specifically, EGR inlet port 148 may be disposed downstream of turbine 136 to receive low-pressure exhaust gas from turbine 136. In the embodiment of FIG. 1, EGR inlet port 148 may also be located downstream of particulate filter 142, but upstream of catalytic device 144. It is contemplated, however, that EGR inlet port 148 may alternatively be located upstream of particulate filter 142 to receive higher pressure exhaust, if desired. However, in this configuration, a separate particulate trap within EGR passageway 150 may be required to reduce particulate matter in the recirculated exhaust. It is also contemplated that EGR inlet port 148 may alternatively be located upstream of turbine 136 to receive high-pressure exhaust gases, if desired.

EGR passageway 150 may fluidly connect EGR inlet port 148 to EGR outlet port 154. Exhaust cooler 152 may be disposed within EGR passageway 150 to cool the portion of the exhaust flowing through EGR inlet port 148. Exhaust cooler 152 may include, for example, a liquid-to-air heat exchanger, an air-to-air heat exchanger, or any other type of heat exchanger known in the art for cooling an exhaust flow. It is contemplated that exhaust cooler 152 may be omitted, if desired.

EGR outlet port 154 may be fluidly connected to throttle valve 156 to direct the exhaust flow from EGR passageway 150 into intake passageway 126 upstream of compressor 128. It is contemplated that EGR outlet port 154 may alternatively be disposed downstream of compressor 128, so that the exhaust from EGR circuit 122 may be mixed with already compressed air before the mixed flow passes through air cooler 132.

Control system 104 may include components that interact to regulate operation of power unit 100 and/or exhaust treatment system 102 in response to an operational parameter of particulate filter 142. For example, control system 104 may include one or more sensors 158 associated with particulate filter 142, and a controller 160 in communication with sensor 158. Sensor 158 may be located within exhaust passageway 140 and embody an absolute pressure sensor, a differential pressure sensor, a temperature sensor, or another sensor known in the art capable of monitoring operation of particulate filter 142.

An absolute pressure sensor may be utilized to determine an absolute pressure of the exhaust upstream of particulate filter 142. For example, an absolute pressure sensor may include a vacuum element and generate a signal indicative of an exhaust pressure magnitude above a reference vacuum pressure. This absolute pressure signal may then be communicated to controller 160.

A differential pressure sensor may be utilized to determine a pressure differential between two locations. For example, a differential pressure sensor may be in fluid communication with exhaust gas at a first location upstream of particulate filter 142 and in fluid communication with exhaust gas at a second location downstream of particulate filter 142. The differential pressure sensor may compare a pressure of exhaust gas at the first location with a pressure of exhaust gas at the second location, and generate a signal indicative of the pressure difference. This differential pressure signal may then be communicated to controller 160.

A temperature sensor may be utilized to determine a temperature of the exhaust. For example, the temperature sensor may be a surface-temperature type sensor that measures the temperature of an inner surface of exhaust passageway 140 upstream of particulate filter 142. Alternatively, the temperature sensor may be an air-temperature type sensor that directly measures the temperature of the exhaust. The temperature sensor may generate a signal indicative of the exhaust temperature and communicate this temperature signal to controller 160.

It is contemplated that sensor 158 may alternatively embody a virtual sensor that generates a signal based on a model-driven estimate. For example, sensor 158 may embody a timer that tracks the time elapsed since the last regeneration event and generates a signal in response to the elapsed time. It is further contemplated that virtual sensor 158 may be included in controller 160.

Controller 160 may be communicatively coupled with sensor 158 to receive the signal(s) generated therefrom. Although not shown, controller 160 may additionally be communicatively coupled with various components of power unit 100 such as, for example, fuel injectors 116, throttle valve 156, compressor 128, air cooler 132, and exhaust cooler 152 to deliver commands affecting their operation. It is contemplated that controller 160 may also be communicatively coupled with systems and components not shown such as, for example, the wastegate, bypass circuit, and engine valves.

Controller 160 may embody a single microprocessor or multiple microprocessors that include a means for controlling one or more operating parameters of power unit 100 and/or exhaust treatment system 102 in response to the signal(s) generated by sensor 158. For example, controller 160 may include a memory, a secondary storage device, and a processor, such as a central processing unit or any other means for controlling a component of power unit 100 in response to the signal(s) generated by sensor 158. Numerous commercially available microprocessors can be configured to perform the functions of controller 160. It should be appreciated that controller 160 could readily embody a general power source microprocessor capable of controlling numerous power source functions. Controller 160 may include a memory, a secondary storage device, a processor, and other components for running an application. It should also be appreciated that controller 160 may include one or more of an application-specific integrated circuit (ASIC), a field programmable gate array (FPGA), a computer system, and a logic circuit, configured to allow controller 160 to function in accordance with the present disclosure. Thus, the memory of controller 160 may embody, for example, the flash memory of an ASIC, flip-flops in an FPGA, the random access memory of a computer system, or a memory circuit contained in a logic circuit. Various other known circuits may be associated with controller 160, including power supply circuitry, signal-conditioning circuitry, solenoid driver circuitry, communication circuitry, and other appropriate circuitry. Controller 160 may be further communicatively coupled with an external computer system, instead of or in addition to including a computer system.

Although not illustrated, controller 160 may be communicatively coupled with input and output components such as, for example, a computer monitor, a printer, an alarm, a warning light, and a direct input button or switch. The computer monitor, printer, alarm, and/or warning light may be activated in response to fault conditions. The direct input button or switch may activate or deactivate aspects of controller's 160 functions, and may allow a user to interface with controller 160.

One or more maps relating absolute pressure, differential pressure, temperature, power unit 100 operating parameters and/or exhaust treatment system 102 parameters may be stored in the memory of controller 160. Each of these maps may be in the form of tables, graphs, and/or equations. Controller 160 may receive the signal(s) generated by sensor 158, and reference map(s) stored in the memory thereof. From these maps, controller 160 may determine a soot loading status of particulate filter 142 and corresponding control commands for power unit 100 and/or exhaust treatment system 102 that accommodates the soot loading during normal operation of particulate filter 142. It is contemplated that controller 160 may also determine similar commands during a regeneration event.

Alternatively, controller 160 may estimate a soot loading status of particulate filter 142 and control operation of power unit 100 in response thereto. For example, controller 160 may track an amount of time elapsed since the last regeneration event and apply this calculated time to a model predicting soot accumulation within particulate filter 142. Alternatively or additionally, controller 160 may monitor engine operating parameters such as, for example, fuel-to-air ratios and/or engine speeds, apply them to calculate a quantity of soot production, and, coupled with an efficiency of particulate filter 142, may determine soot loading therefrom. Based on estimates, controller 160 may determine a command directed to modify operation of power unit 100 to accommodate the soot estimates.

Soot accommodating commands from controller 160 may be used to keep operation of power unit 100 within a desired range and/or limit a maximum output of power unit 100. For example, controller 160 may deliver commands to affect pressures, temperatures, and/or power outputs within power unit 100 and/or exhaust treatment system 102 to minimize the difference between actual pressures, temperatures, and/or power outputs and a range of acceptable pressures, temperatures, and/or power outputs, or to limit a maximum output of power unit 100. Commands delivered by controller 160 may include, for example, fueling commands, air-flow commands, and cooling commands.

Fueling commands may include commands that affect parameters of fuel injectors 116 such as injection timings, pressures, and quantities, a number of injection events, and rate shaping. For example, if, because soot loading reduces the air flow through exhaust treatment system 102 such that power unit 100 produces an undesirably low level of power, controller 160 may deliver a command to increase the amount of fuel delivered into combustion chambers 108, thus increasing the power produced. In another example, if the air-to-fuel ratio drops below an optimum combustion ratio causing decreased efficiency of power unit 100, controller 160 may deliver a command to decrease the amount of fuel delivered into combustion chambers 108, thus increasing the efficiency of power unit 100. In yet another example, if the temperature of particulate filter 142 is above a desired level, controller 160 may similarly deliver a command to decrease the amount of fuel delivered into combustion chambers 108. Controller 160 may alternatively affect a decrease in the amount of fuel delivered into combustion chambers 108 to limit the maximum power output of power unit 100, thus decreasing the temperature.

Air flow commands may include commands that affect air delivery settings of air induction circuit 118 and commands that affect the air-to-exhaust ratio of gases delivered to combustion chambers 108. Such air-to-exhaust affecting commands may change settings such as, for example, compressor 128, wastegate, bypass, throttle valve 156, mixing valve, engine valves, and turbine 136 settings. Settings for the various valves may be directed towards increasing or decreasing the flows through the respective components by, for example, opening or closing the valves, or changing an effective opening or overlap of the valves. In one example, if a low air-to-fuel ratio causes the power produced by power unit 100 to be too low, controller 160 may deliver commands to increase the air flow volume and/or increase the pressure of the air to thereby increase the air-to-fuel ratio and allow for increased fueling. In another example, if the efficiency of power unit 100 is lower than an acceptable threshold or if the temperature of particulate filter 142 is higher than an acceptable threshold, controller 160 may deliver commands to affect an increase in the amount of air delivered to combustion chambers 108, thus increasing the efficiency and/or decreasing the temperature. In yet another example, if backpressure of particulate filter 142 is higher than an acceptable threshold, controller 160 may deliver commands to decrease the amount of air delivered to combustion chambers 108, thus helping to protect power unit 100 from degradation associated with high cylinder pressures. Similarly, controller 160 may affect a decrease in the amount of air delivered to combustion chambers 108 to limit the maximum power output of power unit 100, thus helping to protect power unit 100 from degradation associated with high cylinder pressures.

Cooling commands may include commands that affect operational parameters of air cooler 132 and/or exhaust cooler 152. For example, if the temperature of particulate filter 142 is above an acceptable threshold, controller 160 may deliver commands to increase the cooling temperatures of air cooler 132 and/or exhaust cooler 152. In another example, if the efficiency of power unit 100 is below an acceptable threshold, controller 160 may deliver commands to air cooler 132 and/or exhaust cooler 152 affecting an increase in the amount of air compressed and driven into combustion chambers 108. In yet another example, if the amount of power produced by power unit 100 is lower than an acceptable threshold, controller 160 may deliver commands to air cooler 132 and/or exhaust cooler 152 to allow more air into combustion chambers 108, which in turn may allow more fuel to be delivered to combustion chambers 108.

### INDUSTRIAL APPLICABILITY

The disclosed engine control system may be applicable to an exhaust treatment system having a particulate trap, where loading of the particulate trap may negatively affect engine operation. The disclosed engine control system may improve engine operation by selectively controlling operational parameters in response to a loading state of the particulate trap during normal operation of the trap. The operation of power unit 100 will now be explained.

Atmospheric air may be drawn into air induction circuit 118 through air inlet port 124, further passing through throttle valve 156, and intake passageway 126. The air may be mixed with recirculated exhaust at throttle valve 156 and may be directed through compressor 128 where it may be pressurized before entering intake manifold 110 of power unit 100. The mixture may further pass through air cooler 132 prior to entering intake conduit 130, lowering the temperature of the air/exhaust mixture before it is combusted.

The cooled, pressurized, air/exhaust mixture may then be directed through intake manifold 110 to combustion chambers 108. Fuel may be injected into combustion chambers 108 by fuel injectors 116 and mixed with the cooled, pressurized, air therein. The fuel/air/exhaust mixture may then be combusted by power unit 100 to produce mechanical work output and a hot high-pressure exhaust flow containing gaseous compounds and solid particulate matter. The particulate-laden exhaust flow may then be directed to turbine 136 via exhaust manifold 112 and exhaust conduit 138. As the exhaust enters turbine 136, the expansion of hot exhaust gases may cause turbine 136 to rotate, thereby rotating connected compressor 128. The rotation of turbine 136 may cause compressor 128 to rotate and compress the air/exhaust mixture in intake passageway 126, thereby facilitating movement of the mixture towards power unit 100 for subsequent combustion.

The exhaust flow may then be directed along exhaust passageway 140 to particulate filter 142. Particulate filter 142 may remove some amount of the solid particulate matter from the exhaust flow. Substantially immediately after exiting particulate filter 142, the exhaust gas flow may be divided into two flows, including a first flow directed to EGR circuit 122 and a second flow directed through catalytic device 144 to the atmosphere, catalytic device 144 serving to reduce the amount of NOx and/or further reduce particulate matter exhausted to the atmosphere. It is contemplated that the two flows of exhaust gas may alternatively be divided upstream of particulate filter 142, if desired.

As the first exhaust flow moves through EGR inlet port 148, it may be directed to exhaust cooler 152. The first exhaust flow may be cooled by exhaust cooler 152 to a predetermined temperature, which may further reduce the pressure of the exhaust gases in the first exhaust flow. The first exhaust flow may then be drawn through EGR outlet port 154 and throttle valve 156 back into air induction circuit 118 by compressor 128. The recirculated exhaust flow may then be mixed with the air entering combustion chambers 108 for subsequent combustion.

Further, as the particulate laden exhaust flow is directed from combustion chambers 108 through particulate filter 142, particulate matter may be strained from the exhaust flow by the filtration media of particulate filter 142. Over time, the particulate matter may build up in the filtration media and, if unaccounted for, the buildup could negatively affect operation of power unit 100. The restriction of exhaust flow from power unit 100 may increase the backpressure of power unit 100 and reduce power unit's 100 ability to draw in fresh air, resulting in decreased performance of power unit 100, increased exhaust temperatures, and poor fuel consumption.

To minimize the affect that particulate buildup has on power unit 100 operation, control system 104 may detect or determine the magnitude of the buildup, as disclosed above, and respond accordingly. Specifically, controller 160 may receive the signals generated by sensors 158 and reference the maps stored in the memory of controller 160, and/or utilize a model of soot production or accumulation to estimate a soot loading status of particulate filter 142. Controller 160 may then respond by controlling operational parameters of power unit 100, as disclosed above, to accommodate the building pressure and/or temperature of the exhaust exiting combustion chambers 108. Those skilled in the art will appreciate that the response of controller 160 may be proportional to the amount of detected or determined soot buildup, rather than only responsive to a soot threshold being exceeded.

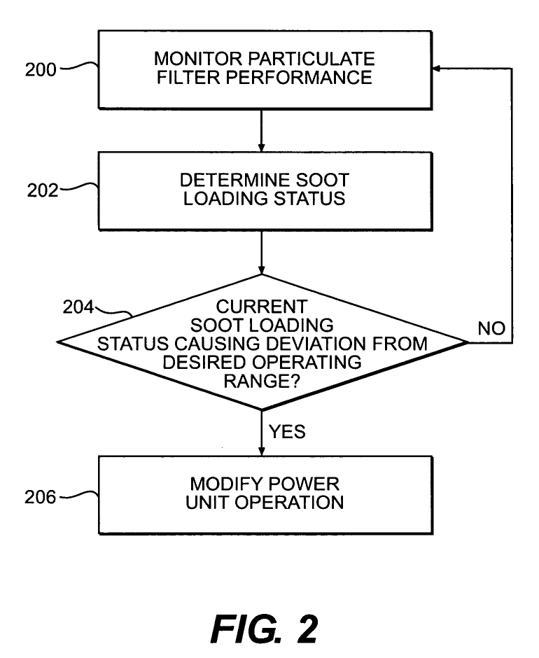

As illustrated in FIG. 2, the method implemented by controller 160 may include monitoring the performance of particulate filter 142 (Step 200). For example, controller 160 may monitor the signal(s) generated by sensor 158. Controller 160 may then reference the maps stored in the memory of controller 160 and/or utilize a model of soot production or accumulation to determine or estimate a soot loading status of particulate filter 142 (Step 202). For example, a pressure differential signal generated by sensor 158 may indicate to controller 160 that particulate filter 142 is about 25% soot-loaded. Controller 160 may then determine whether the soot loading status causes a deviation in the performance of power unit 100 from a desired operating range (Step 204). For example, controller 160 may detect that power unit 100 is producing below an acceptable threshold for efficiency, and determine that the 25% soot-loaded particulate filter 142 is creating a backpressure that limits the amount of air entering combustion chambers 108, thus reducing the efficiency of power unit 100. Controller 160 may then modify operation of power unit 100 based on the determined soot loading status (Step 206) by delivering one or more commands to affect an increase in the efficiency of power unit 100, as described above. It is contemplated that the magnitude of the command may be chosen by controller 160 such that the deviation between the efficiency of power unit 100 and the acceptable threshold is minimized or even eliminated.

The disclosed control system and method may provide a system that periodically alters engine operation to suitably regenerate a particulate-clogged filtration medium, while reducing the negative affects associated with a partially loaded medium between regeneration events. Specifically, by controlling operation parameters of a power unit between regeneration events (i.e. during normal operation of the particulate filter), the control system may serve to reduce the temperature of exhaust gas through a particulate-clogged filtration medium to within an acceptable range. Further, control system may serve to reduce the pressure drop caused by a particulate-clogged filtration medium to within an acceptable range. In reducing the exhaust temperature and associated pressure drop, fuel consumption of the power unit may be reduced and component life may be maximized.

It will be apparent to those skilled in the art that various modifications and variations can be made to the control system and method of the present disclosure without departing from the scope of the disclosure. Other embodiments will be apparent to those skilled in the art from consideration of the specification and practice of the control system disclosed herein. It is intended that the specification and examples be considered as exemplary only, with a true scope of the disclosure being indicated by the following claims and their equivalents.

What is claimed is:

1. A control system for an internal combustion engine having a particulate filter, comprising:
a sensor configured to detect a performance parameter of the particulate filter and generate a corresponding signal; and
a controller in communication with the sensor and the internal combustion engine, the controller configured to:
receive the signal;
determine a soot loading status of the particulate filter based on the signal; and
modify operation of the internal combustion engine based on the soot loading status during normal operation of the particulate filter.

2. The control system of claim 1, wherein:
the internal combustion engine has a desired operating range; and
the controller is further configured to:
determine a soot loading status of the particulate filter causing engine operation to deviate from the desired operating range; and
modify operational parameters of the internal combustion engine based on the soot loading status to minimize the deviation.

3. The control system of claim 1, wherein the sensor is a pressure sensor in communication with exhaust upstream of the particulate filter.

4. The control system of claim 1, wherein the sensor is a temperature sensor associated with the particulate filter.

5. The control system of claim 1, wherein the sensor is a virtual sensor and the signal is generated based on a model-driven estimate.

6. The control system of claim 1, wherein the sensor is a timer configured to track the time elapsed since a regeneration event.

7. The control system of claim 1, wherein the controller modifies operation of the internal combustion engine by changing a fueling parameter.

8. The control system of claim 1, wherein the controller modifies operation of the internal combustion engine by changing an air flow parameter.

9. The control system of claim 1, wherein the controller modifies operation of the internal combustion engine by changing a cooling parameter.

10. The control system of claim 1, wherein the controller modifies operation of the internal combustion engine by limiting a maximum output of the internal combustion engine.

11. A method of controlling engine operation, comprising:
determining a soot loading status of a particulate filter; and
modifying operation of the engine based on the soot loading status during normal operation of the particulate filter.

12. The method of claim 11, further including:
determining a soot loading status causing engine operation to deviate from a desired operating range; and
modifying operational parameters of the engine based on the soot loading status to minimize the deviation.

13. The method of claim 11, wherein determining includes sensing at least one of a pressure and a temperature of exhaust upstream of the particulate filter.

14. The method of claim 11, wherein determining includes estimating the soot loading status based on past engine operation.

15. The method of claim 11, wherein determining includes estimating the soot loading status based on an elapsed period of time since a regeneration event.

16. The method of claim 11, wherein modifying includes changing a fueling parameter.

17. The method of claim 11, wherein modifying includes changing an air flow parameter.

18. The method of claim 11, wherein modifying includes changing a cooling parameter.

19. The method of claim 11, wherein modifying includes limiting a maximum output of the internal combustion engine.

20. A power source, comprising:
an engine having a desired operating range and being configured to combust a fuel/air mixture and produce power and a flow of exhaust;
a filter medium located to receive the flow of exhaust and remove particulate matter therefrom;
a sensor configured to detect a performance parameter of the filter medium and generate a corresponding signal; and
a controller in communication with the sensor and the engine, the controller configured to:
receive the signal;
determine based on the signal a particulate loading status of the filter medium causing engine operation to deviate from the desired operating range; and
to modify operational parameters of the engine based on the particulate loading status to minimize the deviation.
